(19) United States
(12) Patent Application Publication
(10) Pub. No.: US 2010/0023418 A1
(43) Pub. Date: Jan. 28, 2010

(54) METHODS AND SYSTEMS FOR COLLABORATIVE PURCHASE OF GIFTS

(76) Inventors: Bradley Bader, Somerville, MA (US); Daniar Hussain, Cambridge, MA (US)

Correspondence Address: AMERICAN PIONEER VENTURES;ATTN: DANIAR HUSSAIN, 845 Third Avenue, 6th Floor, New York, NY, 10022, US

(21) Appl. No.: 12/363,683

(22) Filed: Jan. 30, 2009

Related U.S. Application Data
(60) Provisional application No. 61/024,765, filed on Jan. 30, 2008.

(51) Int. Cl. G06Q 30/00; G06Q 90/00

(52) U.S. Cl. 705/26; 705/500; 705/1

(57) ABSTRACT

The present invention is a computer-based method and system for coordinating the collaborative selection and purchase of a gift given by any number of gift contributors to a recipient. The gift shopping system maintains updated information on the remaining balance for gift's purchase amount The collaborative gift shopping system processes monetary transactions for each gift contributor until the full purchase amount has been reached. When the full purchase amount is reached by the collaborating gift contributors, the gift order is processed for delivery to the gift recipient. The gift shopping system can send communications to gift contributors each time a contribution towards a gift has been processed. Once the purchase amount of the gift has been reached the gift shopping system can send communications to gift contributors. The gift shopping system can maintain a database for which gifts each recipient has received and/or which gifts are currently accepting contributions to avoid duplicating gifts for that recipient. The gift shopping system can send communications to potential contributors on behalf of gift contributors in the form of invitations to participate in the gift.

### REFERENCE TO RELATED APPLICATIONS

This applications claims priority from U.S. Ser. No. 61/024,765, filed on Jan. 30, 2008, and entitled “Method and system for collaborative purchasing of gifts,” the entirety of which is hereby incorporated by reference herein.

### FIELD OF THE INVENTION

The present invention is generally related to collaborative gift-giving. More specifically, this invention relates to a method and system for coordinating the collaborative selection and purchase of a gift over a network.

### BACKGROUND OF THE INVENTION

Individuals use the facilities of computer networks to act as groups and increase their productivity across a range purposes. This method and system enables individuals to harbor their collaborative capacities to increase their purchasing power for the purpose of purchasing a gift. Individuals that have limited budgets can now use the invention described herein to collaborate with any number of other contributors to purchase a gift of much greater value than would be otherwise possible.

Computer networks across the globe and that incorporate mobile devices such as cellular phones now make it feasible for collaborative activities for a wide range of purposes to take place. Collaborative gift-giving could thus leverage the contributions of hundreds of individuals for the purpose of purchasing a gift for any occasion.

Therefore, as recognized by the present inventors, what are needed are a method, apparatus, and system of collaborative gift-giving.

It is against this background that various embodiments of the present invention were developed.

### BRIEF SUMMARY OF THE INVENTION

One embodiment of the present invention is a computer-based method and system for coordinating the collaborative selection and purchase of a gift given by any number of gift contributors to a recipient. The gift shopping system maintains updated information on the remaining balance for gift's purchase amount The collaborative gift shopping system processes monetary transactions for each gift contributor until the full purchase amount has been reached. When the full purchase amount is reached by the collaborating gift contributors, the gift order is processed for delivery to the gift recipient. The gift shopping system can send communications to gift contributors each time a contribution towards a gift has been processed. Once the purchase amount of the gift has been reached the gift shopping system can send communications to gift contributors. The gift shopping system can maintain a database for which gifts each recipient has received and/or which gifts are currently accepting contributions to avoid duplicating gifts for that recipient. The gift shopping system can send communications to potential contributors on behalf of gift contributors in the form of invitations to participate in the gift.

One embodiment of the present invention is a method for purchasing one or more gifts, comprising selecting the gift from a group of gifts; inviting contributors to contribute one or more contributions to a purchase for the gift; accounting for the contributions of the gift; and purchasing the gift.

Another embodiment of the present invention is the method described above further comprising transmitting a notification to contribute to the gifts to each contributor.

Another embodiment of the present invention is the method described above further comprising updating a balance amount representing collected contributions.

Another embodiment of the present invention is the method described above further comprising setting an expiration date for the purchase of the gifts.

Another embodiment of the present invention is the method described above wherein when the balance amount reaches a predetermined price, the purchase of the gifts is executed.

Another embodiment of the present invention is the method described above wherein when the balance amount reached the predetermined price, no further contributions are permitted.

Another embodiment of the present invention is the method described above further comprising transmitting one or more reminders to the contributors that did not contribute transmitting prior to the expiration date.

Another embodiment of the present invention is the method described above further comprising submitting electronic payment for the contribution to the gifts

Another embodiment of the present invention is the method described above further comprising submitting one or more media segments along with the electronic payment.

Another embodiment of the present invention is the method described above wherein when the expiration date transpires and the balance amount does not reach the predetermined price, the purchase of the purchase is not executed.

Another embodiment of the present invention is a system comprising one or more processors; one or more memories, operatively coupled to the one or more processors, storing program code that when executed by the processors causes the execution of a process comprising displaying a set of gifts; prompting a user to select one or more gifts; prompting the user to invite one or more contributors; and transmitting invitations to the contributors asking the contributors to make a contribution towards a purchase of the gift.

Another embodiment of the present invention is the system described above further comprising program code to execute a process to update a balance amount representing collected contributions.

Another embodiment of the present invention is the system described above further comprising program code to execute a process set an expiration date for the purchase of the gifts.

Another embodiment of the present invention is the system described above further comprising program code to execute a process to submit an order for the gifts when the balance amount reaches a predetermined price.

Another embodiment of the present invention is the system described above wherein when the balance amount reaches the predetermined price, no further contributions are permitted.

Another embodiment of the present invention is the system described above further comprising program code to execute a process to transmit one or more reminders to the contributors that did not contribute prior to the expiration date.

Another embodiment of the present invention is the system described above further comprising program code to execute a process to submit electronic payment to a gift delivery system.

Another embodiment of the present invention is the system described above further comprising program code to execute a process to receive one or more media segments from the contributors

Another embodiment of the present invention is the system described above wherein when the expiration date transpires and the balance amount does not reach the predetermined price, the purchase is not executed.

Another embodiment of the present invention is an apparatus for purchasing one or more gifts, comprising means for selecting the gift from a group of gifts; means for inviting contributors to contribute one or more contributions to a purchase for the gift; means for accounting for the contributions of the gift; and means for purchasing the gift.

Other embodiments of the present invention include the methods corresponding to the systems above, the apparatus corresponding to the systems above, and the methods of operation of the systems described here. Other features and advantages of the various embodiments of the present invention will be apparent from the following more particular description of embodiments of the invention as illustrated in the accompanying drawings.

### BRIEF DESCRIPTION OF THE DRAWINGS

FIG. 1 is a flow diagram of the overall flow of the collaborative gift purchasing system.

FIG. 2 is a block diagram illustrating the components of the collaborative gift purchasing system.

FIG. 3 is a state diagram illustrating the various states of a collaborative gift purchase.

FIG. 4 is a flow diagram of a routine that controls the verification of a collaborative gift recipient.

FIG. 5 is a flow diagram of a routine that controls the processing of a new collaborative gift selection.

FIG. 6 is a flow diagram of a routine that controls the verification of a collaborative gift contribution.

### DETAILED DESCRIPTION OF THE INVENTION

The present invention provides a computer-based method and system for coordinating the selection and purchase of a gift among numerous gift contributors. Gift contributors can be invited to make a payment towards the gift via a number of communication methods (e-mail, SMS, telephone). In one version, the collaborative gift purchasing system of the present invention interacts with gift contributors via the World Wide Web. The collaborative gift shopping system uses a list of other gift contributors provided by the initializing gift contributor to be notified about the newly started gift. Gift contributors can use the notification (such as electronic mail or automated phone message) to respond to the system and make a contribution, or gift contributors can retrieve information about the gift by identifying the gift recipient using a piece of information such as an electronic mail address or telephone number. When contributions reach the full purchase amount, the gift is scheduled for delivery to the recipient.

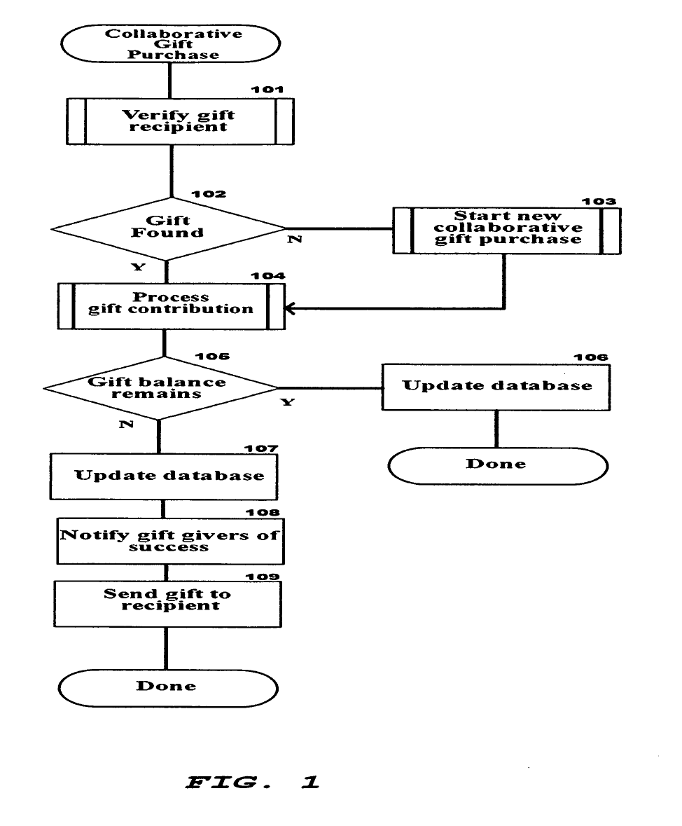

FIG. 1 is a flow diagram of the overall flow of the collaborative gift purchasing system. At step 101, the gift contributor initiates communication with the system and identifies the gift recipient by name or electronic mail address. The system performs a search for matching collaborative gifts at step 102. When a matching gift is retrieved at step 103, the user can proceed to make a contribution towards the collaborative gift at step 105 with various forms of electronic payment such as an electronic check, credit card, or other electronic funds transfer. If no gift is found matching the electronic mail address and/or name provided, then the gift contributor is prompted to start a new collaborative gift at step 104, and select a gift from a selection database in the collaborative gift purchasing system. Once the gift has been initalized the gift contributor can invite other gift contributors by transmitting a list of their electronic mail addresses or telephone numbers for notification. At step 107, the collaborative gift purchasing system's database is updated with the information on the new contribution and/or collaborative gift. If a gift contributor's contribution meets the full purchase amount of the gift (or remaining balance), then all gift contributors who contributed can be notified by a number of methods of communication such as SMS, electronic mail, or telephone, at step 109. When the purchase amount is met the gift is scheduled for delivery to the gift recipient at step 110, indicated at the creation of the collaborative gift.

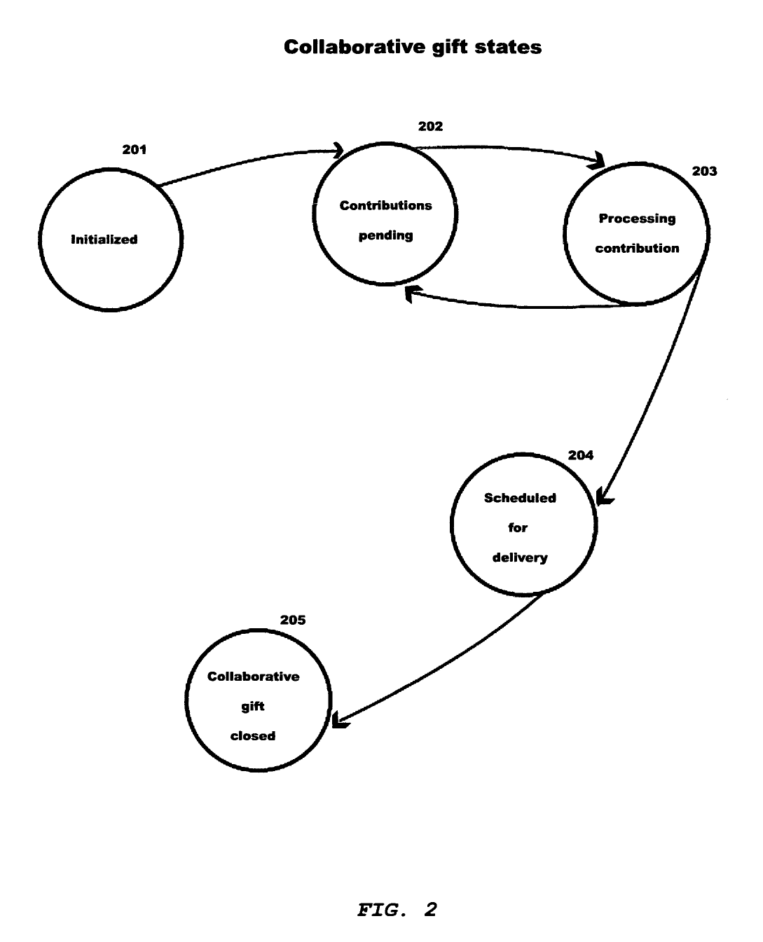

FIG. 2 is a state diagram depicting the various states of a collaborative gift purchase. A collaborative gift purchase can be in one of five states: initalized, pending, processing contribution, scheduled for delivery, and closed. Initially, when a new collaborative gift is selected for a gift recipient and has not received any contributions it is in the initalized state 201. After the system notifies the gift contributors that were indicated at the collaborative gift's creation, receives the first contribution towards the full purchase amount and the delivery information for the gift recipient, the system places the collaborative gift in the contributions pending state 202. Whenever an additional gift contributor retrieves a collaborative gift that is pending contributions, the system enters the contribution processing state 203. When a balance remains on the collaborative gift after each contribution, the system returns the gift to contribution pending state 202. Otherwise, the gift proceeds to the scheduled for delivery state 204. Once scheduled for delivery the collaborative gift changes to the closed state 205.

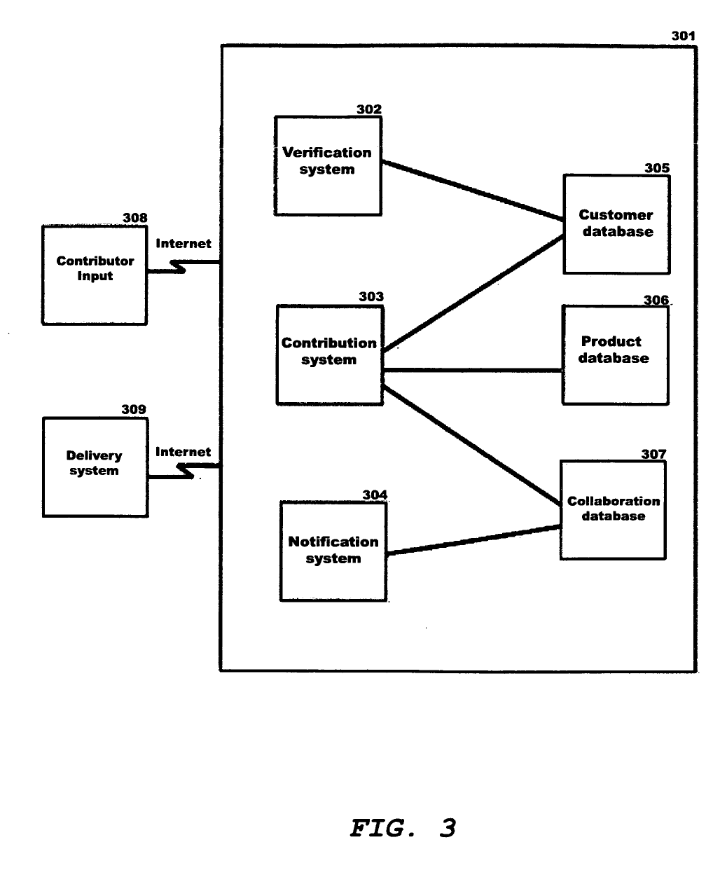

FIG. 3 is a block diagram depicting the components of the collaborative gift purchasing system. Computer system 301 contains a central processing unit, memory, and peripheral devices such as disk drives. The collaborative gift purchasing system includes a verification system 302 a contribution system 303 and a notification system 304. A gift contributor contacts the collaborative gift purchasing system in response to a notification about a collaborative gift, to start a new collaborative gift, or to search for an existing collaborative gift. Contributor input 308 can be transmitted through an automated voice telephone system, web page, or mobile SMS communication.

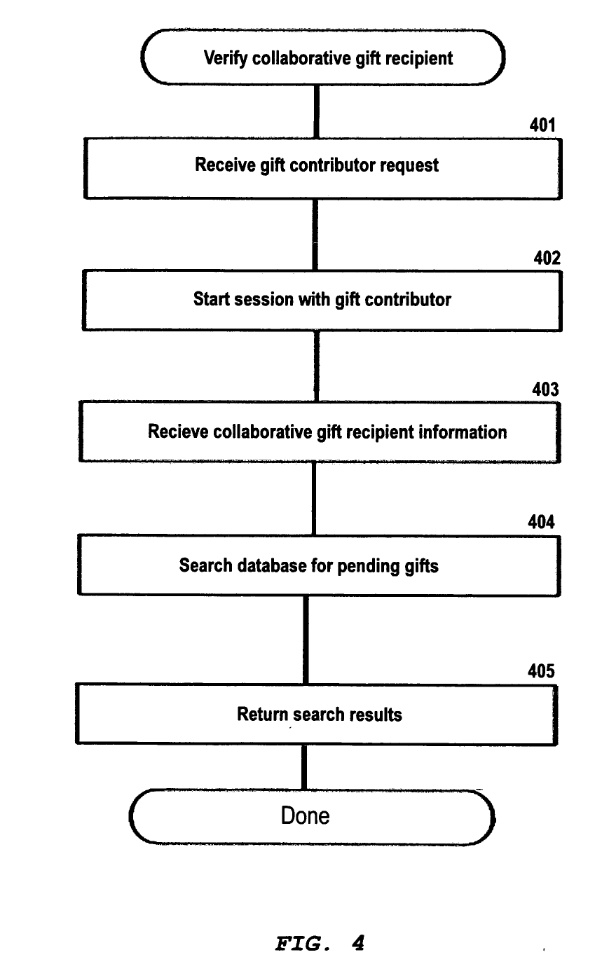

FIG. 4 is a flow diagram of a routine that controls verifying the gift recipient to ensure the gift contributor will interact with the intended collaborative gift. At step 401 the gift contributor sends a request to the system. At step 402 the system starts a session with the gift contributor to track their interaction. The gift contributor provides a piece of the gift recipient's information such as an electronic mail address or phone number to identify the collaborative gift in the system at step 403. The information used for identification is provided by the first contributor when the collaborative gift was created at step 502. At step 404 the system performs a search in its collaborative gifts database for corresponding gift recipients that match the information provided at step 403. At step 405 the system returns any results to the gift contributor indicating the gift selection and the gift's current state. If the system did not find matching results the gift contributor can proceed to create a new collaborative gift purchase at routine 103 or return to step 403 to attempt another search.

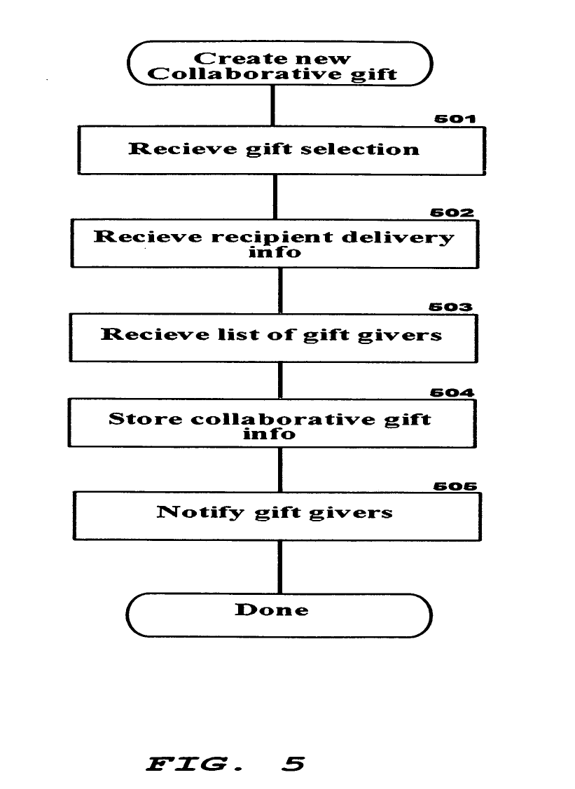

FIG. 5 is a flow diagram of a routine that controls creating a new collaborative gift purchase. At step 501, the gift contributor is prompted to select a gift from the product database. In one embodiment, the gift selection can be received through a web page where the products are organized according to various criteria such as the occasion of the gift, the sex of the gift recipient, or the price range of the products, for example. After a selection has been received, the gift contributor provides the recipient's delivery information in step 502 so the system can schedule the gift for delivery when contributions reach the full purchase amount. At step 503 The gift contributor also provides a list of other gift contributors to notify about the newly created collaborative gift. The system can use various methods to notify additional gift contributors such as electronic mail, telephone, or mobile SMS communication, depending on which information is received from the first gift contributor. The system stores all the information on the new collaborative gift in step 504 for retrieval when another gift contributor uses the system. In step 505, the system sends the notification to all of the other gift contributors received at step 503.

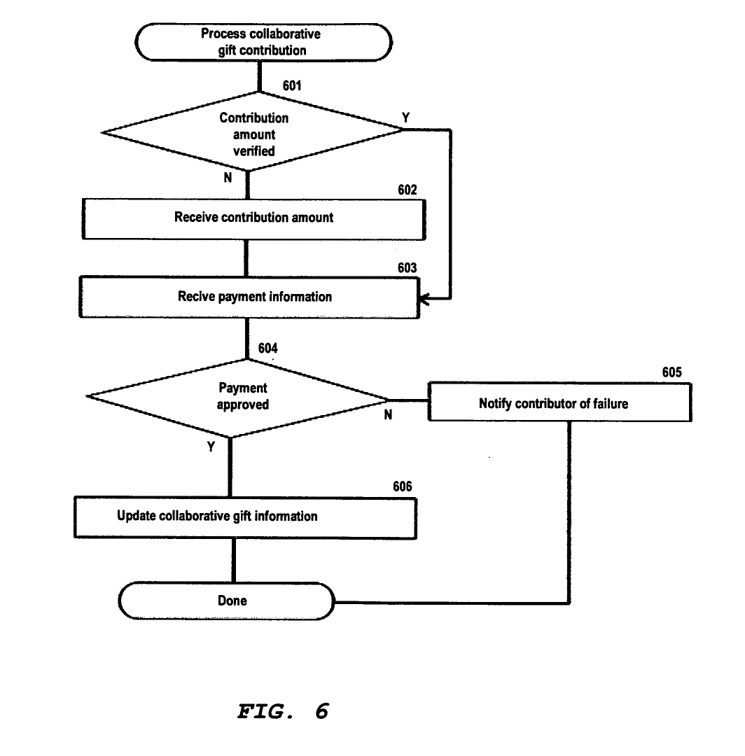

FIG. 6 is a flow diagram of a routine that controls the processing of a gift contribution. At step 601 the gift contributor verifies the contribution amount the system generates based on the anticipated number of gift contributors. The suggested contribution is the full purchase amount of the gift divided by the number gift contributors notified when the gift was first initiated. The contributor can decline the contribution amount and transmit a new amount at step 602. When a contribution amount is verified, the system receives payment information in step 603 in the form of credit card, electronic check, or other electronic funds transfer. In step 604 the payment is approved and the routine continues at step 606, else the routine notifies the gift contributor the payment was declined. In step 606 the routine updates the collaborative gift information such as the remaining balance and number of contributors who have processed payment. If a contribution other than the suggested amount was processed then the contribution schedule is adjusted accordingly. In step 607 the routine ends the session with the gift contributor.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

While the invention has been particularly shown and described with reference to embodiments thereof, it will be understood by those skilled in the art that various other changes in the form and details may be made without departing from the spirit and scope of the invention.

What is claimed is:

1. A method for purchasing one or more gifts, comprising:
selecting the gift from a group of gifts;
inviting contributors to contribute one or more contributions to a purchase for the gift;
accounting for the contributions of the gift; and
purchasing the gift.

2. The method of claim 1, further comprising:
transmitting a notification to contribute to the gifts to each contributor.

3. The method of claim 1, further comprising:
updating a balance amount representing collected contributions.

4. The method of claim 1, further comprising:
setting an expiration date the purchase of the gifts.

5. The method of claim 3, wherein when the balance amount reaches a predetermined price, the purchase of the gifts is executed.

6. The method of claim 3, wherein when the balance amount reached the predetermined price, no further contributions are permitted.

7. The method of claim 1, further comprising:
transmitting one or more reminders to the contributors that did not contribute prior to the expiration date.

8. The method of claim 1, further comprising:
submitting electronic payment for the contribution to the gifts.

9. The method of claim 8, further comprising:
submitting one or more media segments along with the electronic payment.

10. The method of claim 3, wherein when the expiration date transpires and the balance amount does not reach the predetermined price, the purchase is not executed.

11. A system comprising:
one or more processors;
one or more memories, operatively coupled to the one or more processors, storing program code that when executed by the processors causes of the execution of a process comprising:
displaying a set of gifts;
prompting a user to select one or more gifts;
prompting the user to invite one or more contributors; and
transmitting invitations to the contributors asking the contributors to make a contribution towards a purchase of the gift.

12. The system of claim 11, further comprising program code to execute a process to:
update a balance amount representing collected contributions.

13. The system of claim 11, further comprising program code to execute a process to:
setting an expiration date for the purchase of the gifts.

14. The system of claim 12, further comprising program code to execute a process to:
submit an order for the gift when the balance amount reaches a predetermined price.

15. The system of claim 11, wherein when the balance amount reached the predetermined price, no further contributions are permitted.

16. The system of claim 11, further comprising program code to execute a process to:
transmit one or more reminders to the contributors that did not contribute prior to the expiration date.

17. The system of claim 12, further comprising program code to execute a process to:
submit electronic payment to a gift delivery system.

18. The system of claim 12, further comprising program code to execute a process to:
receive one or more media segments from the contributors.

19. The system of claim 12, wherein when the expiration date transpires and the balance amount does not reach the predetermined price, the purchase is not executed.

20. An apparatus for purchasing one or more gifts, comprising:
means for selecting the gift from a group of gifts;
means for inviting contributors to contribute one or more contributions to a purchase for the gift;
means for accounting for the contributions of the gift; and
means for purchasing the gift.
